(19) United States
(12) Patent Application Publication
(10) Pub. No.: US 2021/0189134 A1
(43) Pub. Date: Jun. 24, 2021

(54) Wood Composite Board and Preparation Method Thereof

(71) Applicants: Jiabing Dai, Nanning (CN); Ling Zeng, Nanning (CN); Weihu Li, Nanning (CN); Huayong Yang, Nanning (CN)

(72) Inventors: Jiabing Dai, Nanning (CN); Ling Zeng, Nanning (CN); Weihu Li, Nanning (CN); Huayong Yang, Nanning (CN)

(21) Appl. No.: 16/819,011

(22) Filed: Mar. 13, 2020

(30) Foreign Application Priority Data
Dec. 18, 2019 (CN) 201911312125.7
Dec. 19, 2019 (CN) 201911315066.9

(51) Int. Cl. C08L 97/02; B27N 3/20; B27N 1/02; B27N 7/00; B27N 3/04; B27N 3/02; B27N 3/00

(52) U.S. Cl. CPC C08L 97/02; B27N 3/20; B27N 1/0209; C08L 2205/16; B27N 3/04; B27N 3/02; B27N 3/002; B27N 7/00

(57) ABSTRACT

The invention disclosures a wood composite board and a preparation method thereof, comprising: mixing wood materials with the adhesive evenly, paving the mixed wood materials on the boards, and then forming through high-temperature and hot-pressing, the wood composite board of the invention has good evenness, high surface bonding strength, low moisture content, good dimensional stability, anti-cracking and anti-thermocycling performance, can use compound adhesives such as polyurethane adhesive, formaldehyde-free biomass adhesive or formaldehyde-type adhesives, waterproofing agent, mildew preventive, etc., and by the invention, fiber finish coat with different environmental protection standards can be produced according to market requirements, and the fiber finish coat has a low thickness swelling rate of water absorption and a thickness of 0.5-3 mm.

### BACKGROUND OF THE INVENTION

### 1. Field of the Invention

The invention relates to the technical field of manufacturing composite boards, in particular to a wood composite board and a preparation method thereof.

### 2. Background Art

Wood finish materials have low moisture content, easy processing, and the most widely use, at present, in domestic and foreign markets, the finish materials mainly used in the production of block board are: 1) solid wood board with a thickness of 0.10-0.75 mm, wood species including poplar, mahogany, mangosteen, etc .; 2) integrated materials with a thickness of 0.2-0.6 mm, such as engineered wood; 3) high density fiberboard with a thickness of 1-3 mm;

The above-mentioned wood finish material pressing process refers to that: the lower surface of plywood or block board is pressed to form into base materials of ecological board or finish products through procedures such as coating, cold-pressing, hot-pressing etc., the the finished products of ecological boards are made by pressing and sticking impregnated paper on the base materials of ecological board;

the finished products of ecological boards made by the finish material pressing process: using the base materials of ecological board or finish products pressed from two kinds of finish materials in above mentioned 1) and 2) and pressing and sticking impregnated paper on the upper and lower surfaces of the base materials of ecological board, has the defects of poor surface evenness, low surface bonding strength, high moisture content, poor dimensional stability, and poor anti-cracking and anti-thermocycling performance; the finished products of ecological boards made by the finish material pressing process: using the base materials of ecological board or finish products pressed from two kinds of finish materials in above mentioned 3) and pressing and sticking impregnated paper on the upper and lower surfaces of the base materials of ecological board, has the problems of formaldehyde pollution, low surface bonding strength, large thickness swelling rate of water absorption, large thickness, and high production costs.

### SUMMARY OF THE INVENTION

In order to solve above technical problems, the invention provides the following technical schemes: A wood composite board and preparation method thereof, comprising following steps:

step 1, selecting wood materials and adhesives, wherein the moisture content of the wood materials is 0%-9%, and the adhesive is polyurethane adhesive, formaldehyde-free biomass adhesive or formaldehyde-type adhesives; applying the adhesives into the wood materials and stirring, adhesive consumption is 7%-35% of the weight of the wood materials, applying waterproof agent and mildew preventive into the wood materials, and thereafter drying the wood materials to a moisture content of 3%-15%;

step 2, selecting board, evenly coating the adhesives on the upper and lower surfaces of the board, and coating amount of each surface is 100 g/m²-120 g/m², evenly paving the wood materials prepared in step 1 on the upper and lower surfaces of the board, paving amount thereof is 0.5 kg/m²-3.9 kg/m² and paving depth is 1 mm-3 mm;

step 3, after the paving in step 2, the wood composite board is made through high-temperature and hot-pressing, hot-pressing temperature is 100° C-150° C., hot-pressing pressure and time are divided into three stages: in the first stage, the pressure is 0.7 MPa-0.9 MPa for the time of 3-10 min, in the second stage, the pressure is 0.3 MPa-0.5 MPa for the time of 1-10 min, in the third stage, the pressure is 0.0 MPa-0.3 MPa for the time of 1-10 min;

step 4, after the hot-pressing in step 3, air cooling the wood composite board for more than 5 min, and then collecting and stacking thereof; reconditioning the wood composite board naturally for more than 7 days, and trimming and sanding to determine the thickness, the thickness error of the board is controlled in ±0.1 mm.

Preferably, the wood materials is wood fiber, the fineness degree thereof is 0.2-0.6 mm, the moisture content of the selected wood fiber is 0%-9%; when the wood materials is wood fiber, the added amount of waterproof agent is 0.3% -0.6% of the weight of the wood materials, the added amount of mildew preventive is 0.1%-0.4% of the weight of the wood materials, and after applying, drying the wood materials to a moisture content of 3%-15%.

Preferably, when the wood materials is wood fiber, the paving amount thereof on the board is 0.7 kg/m²-3.9 kg/m².

Preferably, the wood materials is wood particle, screen mesh size thereof is less than or equal to 1.53*1.53 mm and greater than or equal to 0.11*0.11 mm, the moisture content of the selected wood particle is 0%-3%; when the wood materials is wood particle, the added amount of waterproof agent is 0.05%-3.4% of the weight of the wood materials, the added amount of mildew preventive is 0.01%-4.5% of the weight of the wood materials, and after applying, drying the wood materials to a moisture content of 5%-12%.

Preferably, when the wood materials is wood particle, the paving amount thereof on the board is 0.5 kg/m²-3.5 kg/m².

Preferably, the selected board in step 2 has a thickness of 5-21 mm, a length of 2450-2750 mm, and a width of 1230-1310 mm.

Preferably, the selected board in step 2 is plywood, block board, oriented particle board, straw board or any combination of artificial boards.

By adapting above methods, the invention has following advantages: 1. the wood artificial composite board of the invention has good evenness, high surface bonding strength, low moisture content, good dimensional stability, anti-cracking and anti-thermocycling performance.

2. The wood material of the invention uses compound adhesives such as polyurethane adhesive, formaldehyde-free biomass adhesive or formaldehyde-type adhesives (urea-formaldehyde, phenol-formaldehyde, and melamine-formaldehyde), waterproofing agent, mildew preventive, etc., and has a low thickness swelling rate of water absorption, the thickness can be less than 1 mm, and the production cost is low.

3. Plywood, block board, oriented particle board, straw board or any combination of artificial boards are formed by paving glue blending wood materials and through hot-pressing, the surfaces of the artificial boards can be glue-free, which saves production costs.

4. The wood materials can be made from waste materials such as branches wood and small logs, recycling waste materials, and solving the problem of lack of wood raw materials.

5. The wood materials has a certain thickness, when the thickness of finished products remains unchanged, the thickness of plywood, block board, oriented particle board, straw board or any combination of artificial boards used for direct sticking is reduced, which saves production costs.

### DETAILED DESCRIPTION OF THE PREFERRED EMBODIMENTS

Preparing wood fiber composite board

### Embodiment 1

A preparation method of a wood composite board, comprising following steps:

step 1, selecting wood fiber and adhesives, wherein the fineness degree thereof is 0.2 mm, the moisture content thereof is 3%, the adhesive is polyurethane adhesive, formaldehyde-free biomass adhesive or formaldehyde-type adhesives; applying the adhesives into the wood fiber and stirring, adhesive consumption is 7% of the weight of the wood fiber, applying waterproof agent into the wood fiber, additive amount thereof is 0.3% of the weight of the wood fiber, and applying mildew preventive, additive amount thereof is 0.1% of the weight of the wood fiber, and thereafter drying the wood fiber to a moisture content of 3%;

step 2, selecting board, the board is plywood, block board, oriented particle board, straw board or any combination of artificial boards, and the selected board has a thickness of 5 mm, a length of 2450 mm, and a width of 1230 mm, evenly coating the adhesives on the upper and lower surfaces of the board, and coating amount of each surface is 100 g/m², evenly paving the wood fiber prepared in step 1 on the upper and lower surfaces of the board, paving amount thereof is 0.7 kg/m² and paving depth is 1 mm;

step 3, after the paving in step 2, the wood fiber composite board is made through high-temperature and hot-pressing, hot-pressing temperature is 100° C. , hot-pressing pressure and time are divided into three stages: in the first stage, the pressure is 0.7 MPa for the time of 3 min, in the second stage, the pressure is 0.3 MPa for the time of 1 min, in the third stage, the pressure is 0.0 MPa for the time of 1 min;

step 4, after the hot-pressing in step 3, air cooling the wood fiber composite board for more than 5 min, and then collecting and stacking thereof; reconditioning the wood fiber composite board naturally for more than 7 days, and trimming and sanding to determine the thickness, the thickness error of the board is controlled in ±0.1 mm.

### Embodiment 2

A preparation method of a wood composite board, comprising following steps:

step 1, selecting wood fiber and adhesives, wherein the fineness degree thereof is 0.6 mm, the moisture content thereof is 9%, the adhesive is polyurethane adhesive, formaldehyde-free biomass adhesive or formaldehyde-type adhesives; applying the adhesives into the wood fiber and stirring, adhesive consumption is 35% of the weight of the wood fiber, applying waterproof agent into the wood fiber, additive amount thereof is 0.6% of the weight of the wood fiber, and applying mildew preventive, additive amount thereof is 0.4% of the weight of the wood fiber, and thereafter drying the wood fiber to a moisture content of 15%;

step 2, selecting board, the board is plywood, block board, oriented particle board, straw board or any combination of artificial boards, and the selected board has a thickness of 21 mm, a length of 2750 mm, and a width of 1310 mm, evenly coating the adhesives on the upper and lower surfaces of the board, and coating amount of each surface is 120 g/m², evenly paving the wood fiber prepared in step 1 on the upper and lower surfaces of the board, paving amount thereof is 3.9 kg/m² and paving depth is 3 mm;

step 3, after the paving in step 2, the wood fiber composite board is made through high-temperature and hot-pressing, hot-pressing temperature is 150 , hot-pressing pressure and time are divided into three stages: in the first stage, the pressure is 0.9 MPa for the time of 10 min, in the second stage, the pressure is 0.5 MPa for the time of 10 min, in the third stage, the pressure is 0.3 MPa for the time of 10 min;

step 4, after the hot-pressing in step 3, air cooling the wood fiber composite board for more than 5 min, and then collecting and stacking thereof; reconditioning the wood fiber composite board naturally for more than 7 days, and trimming and sanding to determine the thickness, the thickness error of the board is controlled in ±0.1 mm.

### Embodiment 3

A preparation method of a wood composite board, comprising following steps:

step 1, selecting wood fiber and adhesives, wherein the fineness degree thereof is 0.4 mm, the moisture content thereof is 5%, the adhesive is polyurethane adhesive, formaldehyde-free biomass adhesive or formaldehyde-type adhesives; applying the adhesives into the wood fiber and stirring, adhesive consumption is 20% of the weight of the wood fiber, applying waterproof agent into the wood fiber, additive amount thereof is 0.5% of the weight of the wood fiber, and applying mildew preventive, additive amount thereof is 0.3% of the weight of the wood fiber, and thereafter drying the wood fiber to a moisture content of 9%;

step 2, selecting board, the board is plywood, block board, oriented particle board, straw board or any combination of artificial boards, and the selected board has a thickness of 13 mm, a length of 2650 mm, and a width of 1280 mm, evenly coating the adhesives on the upper and lower surfaces of the board, and coating amount of each surface is 110 g/m², evenly paving the wood fiber prepared in step 1 on the upper and lower surfaces of the board, paving amount thereof is 2 kg/m² and paving depth is 2 mm;

step 3, after the paving in step 2, the wood fiber composite board is made through high-temperature and hot-pressing, hot-pressing temperature is 130° C. , hot-pressing pressure and time are divided into three stages: in the first stage, the pressure is 0.8 MPa for the time of 6 min, in the second stage, the pressure is 0.4 MPa for the time of 6 min, in the third stage, the pressure is 0.2 MPa for the time of 6 min;

step 4, after the hot-pressing in step 3, air cooling the wood fiber composite board for more than 5 min, and then collecting and stacking thereof; reconditioning the wood fiber composite board naturally for more than 7 days, and trimming and sanding to determine the thickness, the thickness error of the board is controlled in ±0.1 mm.

TABLE 1
Test Results of Wood Fiber Composite Board in the Invention

| | | Standard | Test Results | | | Inspection | |
|---|---|---|---|---|---|---|---|
| Test Items | Unit | Requirement | Embodiment 1 | Embodiment 2 | Embodiment 3 | Standards | Others |
| Surface Bonding | MPa | ≥1.0 | 1.2 | 1.3 | 1.4 | GB/T17657- | Between the |
| Strength | | | | | | 2013 Test | fiber layer |
| | | | | | | Methods of | and the |
| | | | | | | Evaluating | wood-based |
| | | | | | | the | panel layer |
| Thickness | % | ≤15 | 10 | 10 | 11 | Properties of | — |
| Swelling Rate of | | | | | | Wood-based | |
| Water Absorption | | | | | | Panels and | |
| in 24 h | | | | | | Surface | |
| Formaldehyde | mg/L | <0.10 | 0.09 | 0.07 | 0.05 | Decorated | — |
| Emission | | | | | | wood-based | |
| Surface | degree | ≤5 | 4 | 5 | 5 | panels | |
| Anti-thermocycling | | | | | | | |
| Performance | | | | | | | |
| Surface | degree | ≤5 | 3 | 4 | 5 | | |
| Anti-cracking | | | | | | | |
| Performance | | | | | | | |

Preparing wood particle composite board

### Embodiment 4

A preparation method of a wood composite board, comprising following steps:

step 1, selecting wood particle and adhesives, wherein the screen mesh size thereof is less than or equal to 1.53*1.53 mm and greater than or equal to 0.11*0.11 mm, the moisture content thereof is 1%, the adhesive is polyurethane adhesive, formaldehyde-free biomass adhesive or formaldehyde-type adhesives; applying the adhesives into the wood materials and stirring, adhesive consumption is 7% of the weight of the wood materials, applying waterproof agent into the wood materials, additive amount thereof is 0.05% of the weight of the wood materials, and applying mildew preventive, additive amount thereof is 0.01% of the weight of the wood materials, and thereafter drying the wood materials to a moisture content of 3%;

step 2, selecting board, the board is plywood, block board, oriented particle board, straw board or any combination of artificial boards, and the selected board has a thickness of 5 mm, a length of 2450 mm, and a width of 1230 mm, evenly coating the adhesives on the upper and lower surfaces of the board, and coating amount of each surface is 100 g/m², evenly paving the wood fiber prepared in step 1 on the upper and lower surfaces of the board, paving amount thereof is 0.5 kg/m² and paving depth is 1 mm;

step 3, after the paving in step 2, the wood composite board is made through high-temperature and hot-pressing, hot-pressing temperature is 100° C. , hot-pressing pressure and time are divided into three stages: in the first stage, the pressure is 0.7 MPa for the time of 3 min, in the second stage, the pressure is 0.3 MPa for the time of 1 min, in the third stage, the pressure is 0.0 MPa for the time of 1 min;

step 4, after the hot-pressing in step 3, air cooling the wood composite board for more than 5 min, and then collecting and stacking thereof; reconditioning the wood composite board naturally for more than 7 days, and trimming and sanding to determine the thickness, the thickness error of the board is controlled in ±0.1 mm.

### Embodiment 5

A preparation method of a wood composite board, comprising following steps:

step 1, selecting wood particle and adhesives, wherein the screen mesh size thereof is less than or equal to 1.53*1.53 mm and greater than or equal to 0.11*0.11 mm, the moisture content thereof is 3%, the adhesive is polyurethane adhesive, formaldehyde-free biomass adhesive or formaldehyde-type adhesives; applying the adhesives into the wood materials and stirring, adhesive consumption is 35% of the weight of the wood materials, applying waterproof agent into the wood materials, additive amount thereof is 3.4% of the weight of the wood materials, and applying mildew preventive, additive amount thereof is 4.5% of the weight of the wood materials, and thereafter drying the wood materials to a moisture content of 15%;

step 2, selecting board, the board is plywood, block board, oriented particle board, straw board or any combination of artificial boards, and the selected board has a thickness of 21 mm, a length of 2750 mm, and a width of 1310 mm, evenly coating the adhesives on the upper and lower surfaces of the board, and coating amount of each surface is 120 g/m², evenly paving the wood fiber prepared in step 1 on the upper and lower surfaces of the board, paving amount thereof is 3.5 kg/m² and paving depth is 3 mm;

step 3, after the paving in step 2, the wood composite board is made through high-temperature and hot-pressing, hot-pressing temperature is 150° C., hot-pressing pressure and time are divided into three stages: in the first stage, the pressure is 0.9 MPa for the time of 10 min, in the second stage, the pressure is 0.5 MPa for the time of 10 min, in the third stage, the pressure is 0.3 MPa for the time of 10 min;

step 4, after the hot-pressing in step 3, air cooling the wood composite board for more than 5 min, and then collecting and stacking thereof; reconditioning the wood composite board naturally for more than 7 days, and trimming and sanding to determine the thickness, the thickness error of the board is controlled in ±0.1 mm.

### Embodiment 6

A preparation method of a wood composite board, comprising following steps:

step 1, selecting wood particle and adhesives, wherein the screen mesh size thereof is less than or equal to 1.53*1.53 mm and greater than or equal to 0.11*0.11 mm, the moisture content thereof is 2%, the adhesive is polyurethane adhesive, formaldehyde-free biomass adhesive or formaldehyde-type adhesives; applying the adhesives into the wood materials and stirring, adhesive consumption is 20% of the weight of the wood materials, applying waterproof agent into the wood materials, additive amount thereof is 1.7% of the weight of the wood materials, and applying mildew preventive, additive amount thereof is 2.3% of the weight of the wood materials, and thereafter drying the wood materials to a moisture content of 9%;

step 2, selecting board, the board is plywood, block board, oriented particle board, straw board or any combination of artificial boards, and the selected board has a thickness of 13 mm, a length of 2550 mm, and a width of 1280 mm, evenly coating the adhesives on the upper and lower surfaces of the board, and coating amount of each surface is 110 g/m², evenly paving the wood fiber prepared in step 1 on the upper and lower surfaces of the board, paving amount thereof is 2 kg/m² and paving depth is 2 mm;

step 3, after the paving in step 2, the wood composite board is made through high-temperature and hot-pressing, hot-pressing temperature is 120° C. , hot-pressing pressure and time are divided into three stages: in the first stage, the pressure is 0.8 MPa for the time of 6 min, in the second stage, the pressure is 0.4 MPa for the time of 6 min, in the third stage, the pressure is 0.2 MPa for the time of 6 min;

step 4, after the hot-pressing in step 3, air cooling the wood composite board for more than 5 min, and then collecting and stacking thereof; reconditioning the wood composite board naturally for more than 7 days, and trimming and sanding to determine the thickness, the thickness error of the board is controlled in ±0.1 mm.

TABLE 2
Test Results of Wood Particle Composite Board in the Invention

| | | Standard | Test Results | | | Inspection | |
|---|---|---|---|---|---|---|---|
| Test Items | Unit | Requirement | Embodiment 4 | Embodiment 5 | Embodiment 6 | Standards | Others |
| Surface Bonding | MPa | ≥1.0 | 1.2 | 1.3 | 1.4 | GB/T17657- | Between the |
| Strength | | | | | | 2013 Test | particle layer |
| | | | | | | Methods of | and the |
| | | | | | | Evaluating | wood-based |
| | | | | | | the | panel layer |
| Thickness | % | ≤15 | 13 | 12 | 11 | Properties of | — |
| Swelling Rate of | | | | | | Wood-based | |
| Water Absorption | | | | | | Panels and | |
| in 24 h | | | | | | Surface | |
| Formaldehyde | mg/L | <0.10 | 0.09 | 0.07 | 0.05 | Decorated | — |
| Emission | | | | | | wood-based | |
| Surface | degree | ≤5 | 4 | 5 | 5 | panels | |
| Anti-thermocycling | | | | | | | |
| Performance | | | | | | | |
| Surface | degree | ≤5 | 3 | 4 | 5 | | |
| Anti-cracking | | | | | | | |
| Performance | | | | | | | |

The invention and embodiments thereof have been described above, and the description is not restrictive, in conclusion, the similar structures and embodiments with the technical scheme of the invention, which are designed by those skilled in the art inspired by the invention, without creativity and without departing from the spirit of the invention, should be included in the protection scope of the invention.

1. A preparation method of a wood composite board, comprising following steps:
step 1, selecting wood materials and adhesives, wherein the moisture content of the wood materials is 0%-9%, and the adhesive is polyurethane adhesive, formaldehyde-free biomass adhesive or formaldehyde-type adhesives; applying the adhesives into the wood materials and stirring, adhesive consumption is 7%-35% of the weight of the wood materials, applying waterproof agent and mildew preventive into the wood materials, and thereafter drying the wood materials to a moisture content of 3%-15%;
step 2, selecting board, evenly coating the adhesives on the upper and lower surfaces of the board, and coating amount of each surface is 100 g/m²-120 g/m², evenly paving the wood materials prepared in step 1 on the upper and lower surfaces of the board, paving amount thereof is 0.5 kg/m²-3.9 kg/m² and paving depth is 1 mm-3 mm;
step 3, after the paving in step 2, the wood composite board is made through high-temperature and hot-pressing, hot-pressing temperature is 100° C. -150° C., hot-pressing pressure and time are divided into three stages: in the first stage, the pressure is 0.7 MPa-0.9 MPa for the time of 3-10 min, in the second stage, the pressure is 0.3 MPa-0.5 MPa for the time of 1-10 min, in the third stage, the pressure is 0.0 MPa-0.3 MPa for the time of 1-10 min;
step 4, after the hot-pressing in step 3, air cooling the wood composite board for more than 5 min, and then collecting and stacking thereof; reconditioning the wood composite board naturally for more than 7 days, and trimming and sanding to determine the thickness, the thickness error of the board is controlled in ±0.1 mm.

2. The preparation method of a wood composite board of claim 1, wherein the wood materials is wood fiber, the fineness degree thereof 0.2-0.6 mm, the moisture content of the selected wood fiber is 0%-9%; when the wood materials is wood fiber, the added amount of waterproof agent is 0.3% -0.6% of the weight of the wood materials, the added amount of mildew preventive is 0.1%-0.4% of the weight of the wood materials, and after applying, drying the wood materials to a moisture content of 3%-15%.

3. The preparation method of a wood composite board of claim 1, wherein when the wood materials is wood fiber, the paving amount thereof on the board is 0.7 kg/m²-3.9 kg/m².

4. The preparation method of a wood composite board of claim 1, wherein the wood materials is wood particle, screen mesh size thereof is less than or equal to 1.53*1.53 mm and greater than or equal to 0.11*0.11 mm, the moisture content of the selected wood particle is 0%-3%; when the wood materials is wood particle, the added amount of waterproof agent is 0.05%-3.4% of the weight of the wood materials, the added amount of mildew preventive is 0.01%-4.5% of the weight of the wood materials, and after applying, drying the wood materials to a moisture content of 5%-12%.

5. The preparation method of a wood composite board of claim 1, wherein when the wood materials is wood particle, the paving amount thereof on the board is 0.5 kg/m²-3.5 kg/m².

6. The preparation method of a wood composite board of claim 1, wherein the selected board in step 2 has a thickness of 5-21 mm, a length of 2450-2750 mm, and a width of 1230-1310 mm.

7. The preparation method of a wood composite board of claim 1, wherein the selected board in step 2 is plywood, block board, oriented particle board, straw board or any combination of artificial boards.
